(19) United States
(12) Patent Application Publication
(10) Pub. No.: US 2010/0064913 A1
(43) Pub. Date: Mar. 18, 2010

(54) Screen Printer

(75) Inventors: Rebecca Sego, Spanish Fork, UT (US); Michael Horito, Provo, UT (US); Matt B. Strong, Pleasant Grove, UT (US); Jared Burton, Payson, UT (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Provo Craft and Novelty, Inc., Spanish Fork, UT (US)

(21) Appl. No.: 12/472,247

(22) Filed: May 26, 2009

Related U.S. Application Data
(60) Provisional application No. 61/055,779, filed on May 23, 2008.

(51) Int. Cl. B05C 17/08

(52) U.S. Cl. 101/126

(57) ABSTRACT

A screen printer includes a support portion and a cover portion movably-connected to the support portion. The cover portion includes a body defining a passage, an upper surface, and a lower surface, The lower surface includes a portion for retaining the screen body.

### CROSS REFERENCE TO RELATED APPLICATIONS

This application claims priority under 35 USC 119(e) to U.S. Provisional Patent Application No. 61/055,779 filed on May 23, 2008, titled “SILK SCREENER”, to Rebecca Sego, the contents of which are incorporated in their entirety herein by reference.

### FIELD OF THE INVENTION

The disclosure relates to a screen printer.

### DESCRIPTION OF THE RELATED ART

Silk-screening is a printing technique that dates back to the late 1800's/early 1900's for creating designs on various substrates, such as textile fabric, paper, metal, wood, glass, etc. However, many silk screening apparatuses are designed for large industrial applications, and not easily accessible to a home-user. The making of screens may have also included specialized ultraviolet (UV) light sources for exposing emulsified screens, that may not have been desirable due to their expense. Moreover, the screen printing applications were not modeled for ease of use for a single person. They typically included multiple stations and or manufacturing steps to make the screens and to print a garment.

Screen printing has become useful for making designs on textiles, e.g., a shirt, and may also be used to create single and multicolored designs. However, the machines used for screen printing may be too large or cumbersome. Typically multi-color screen printers have complex and expensive designs which may be cumbersome or lack adjustability for varied use.

Thus, there is a need in the art to provide a novel screen printer and method for using the same. Moreover, there is a need to provide a simple, adjustable, and affordable multi-purpose machine for making single and multi-color designs.

### BRIEF DESCRIPTION OF THE DRAWINGS

The disclosure will now be described, by way of example, with reference to the accompanying drawings, in which:

FIG. 1 is an exploded perspective view of a screen printer in accordance with an exemplary embodiment of the invention.

FIG. 2 is a perspective view of the screen printer according to FIG. 1.

FIG. 3 is a perspective view of the screen printer according to FIG. 1.

FIG. 4 is a perspective view of the screen printer according to FIG. 1.

FIGS. 5A-5X illustrate a method of utilizing the silk screen in accordance with an exemplary embodiment of the invention.

FIGS. 6A-6D illustrate a method of preparing a grid portion attached to a screen body.

FIG. 7 is an example of a method for silk screening.

FIG. 8A is a top view of a platen for use with the screen printer.

FIG. 8B is a cross-sectional view of a the platen of FIG. 8A.

FIG. 8C is a top perspective view of a the platen of FIG. 8A.

FIG. 8D is a bottom perspective view of a the platen of FIG. 8A.

FIG. 9 is a cross-sectional view of the platen in use.

FIG. 10 is a top view of a registration pane for use with the screen printer.

FIG. 11 is an example of artwork registration for use with the screen printer.

### DETAILED DESCRIPTION OF THE INVENTION

The Figures illustrate an exemplary embodiment of a screen printer in accordance with an embodiment of the invention. Based on the foregoing, it is to be generally understood that the nomenclature used herein is simply for convenience and the terms used to describe the invention should be given the broadest meaning by one of ordinary skill in the art. As discussed herein, the terms “silk screen” and “screen printing” may be used interchangeably. This application claims priority under 35 USC 119(e) to U.S. Provisional Patent Application No. 61/055,779 filed on May 23, 2008, titled “SILK SCREENER”, to Rebecca Sego, the contents of which are incorporated herein in their entirety by reference.

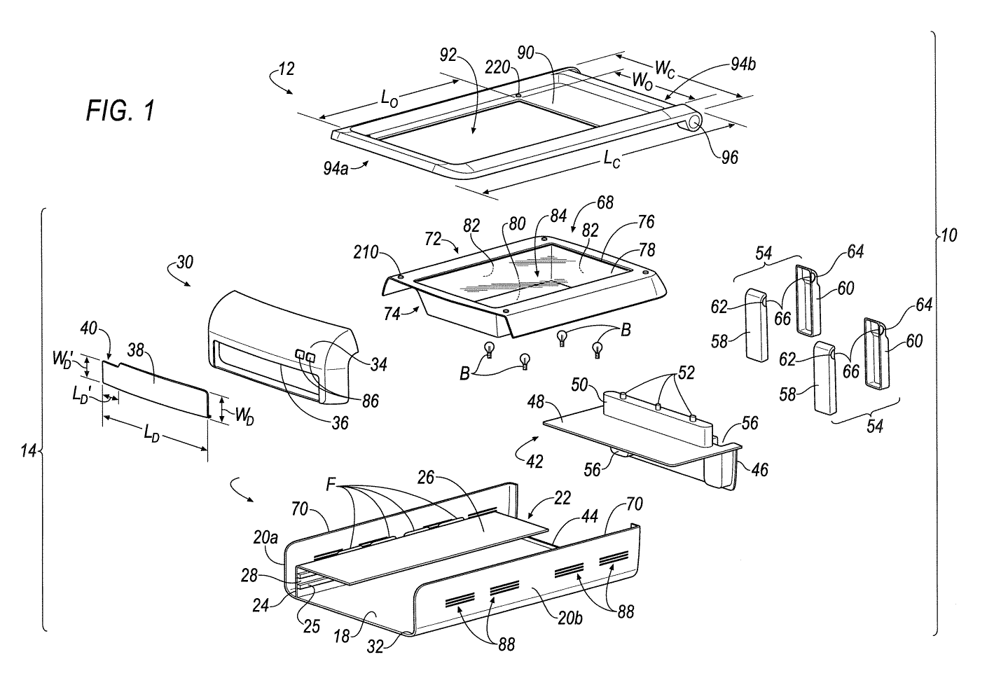

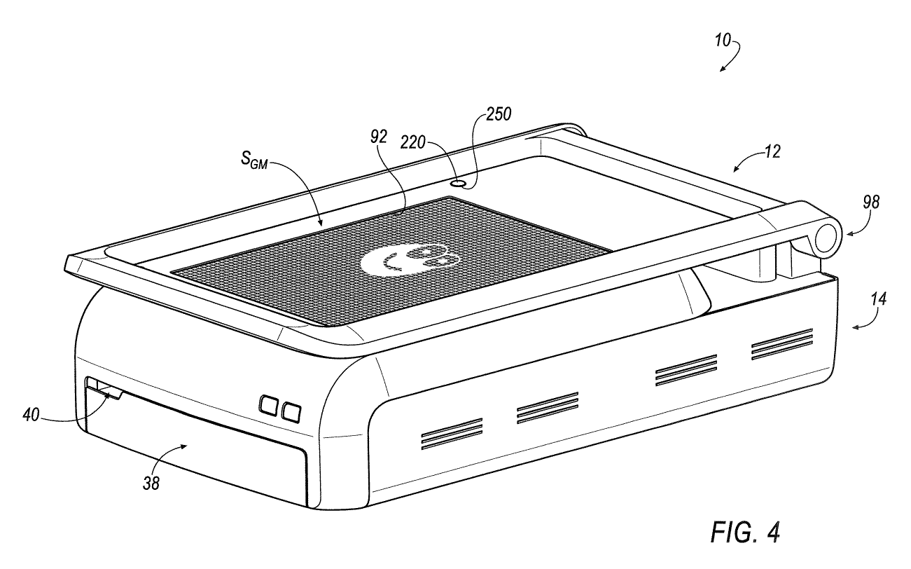

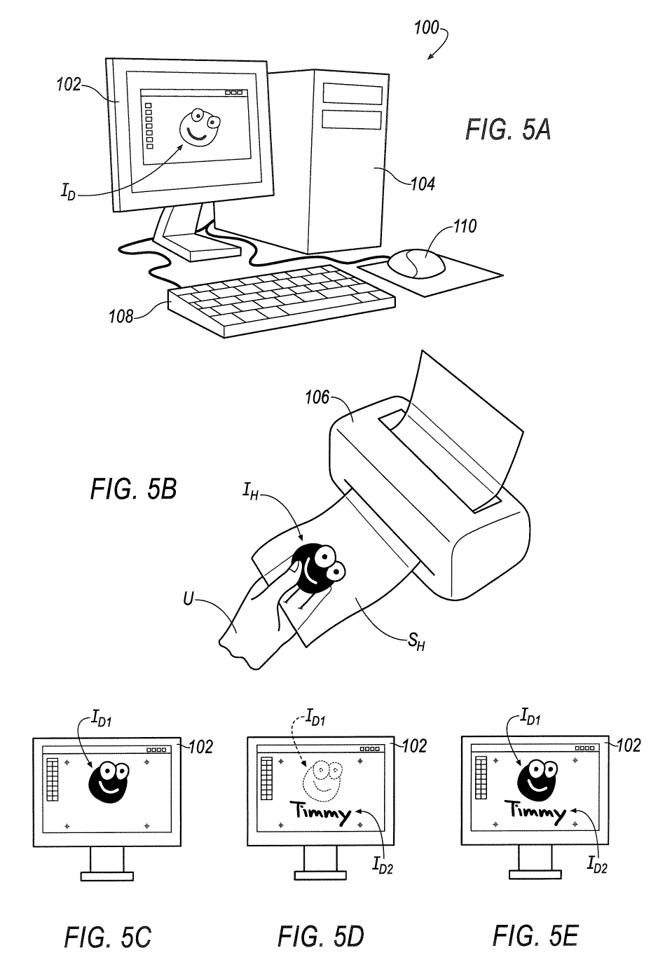

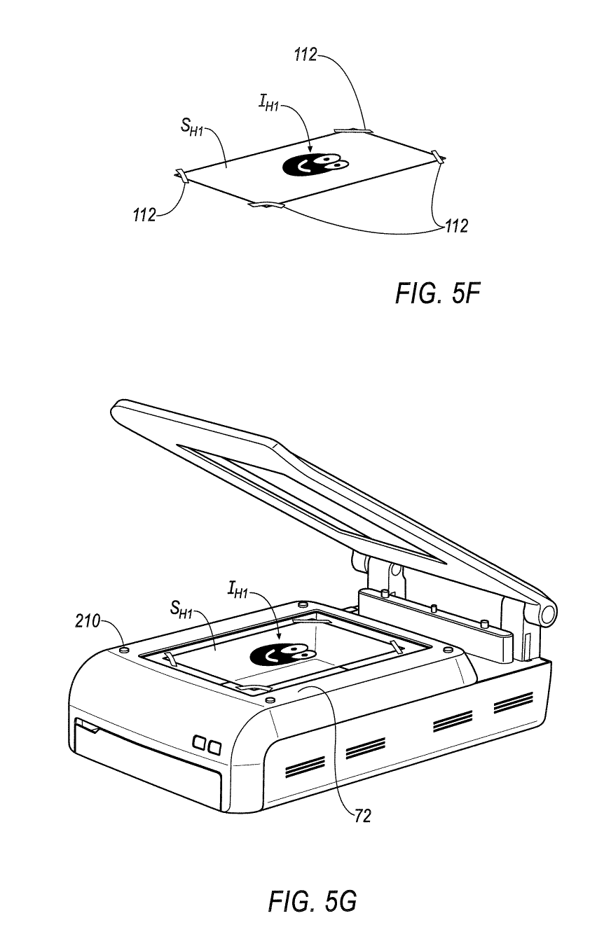

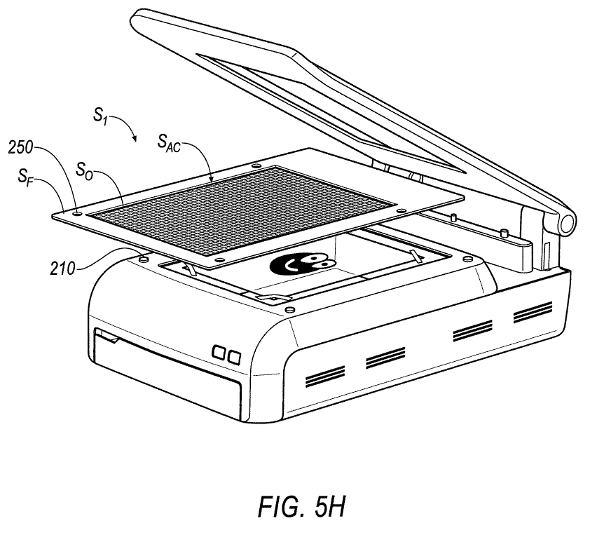

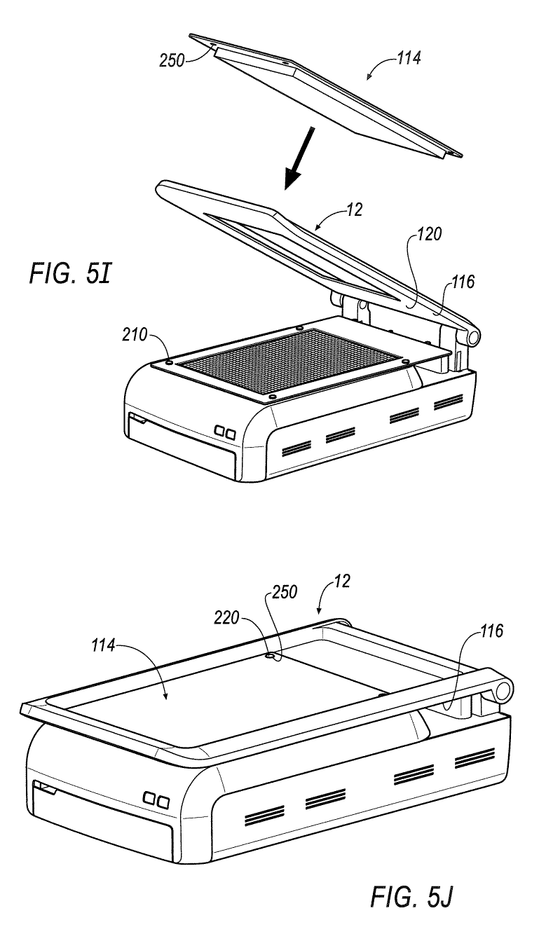

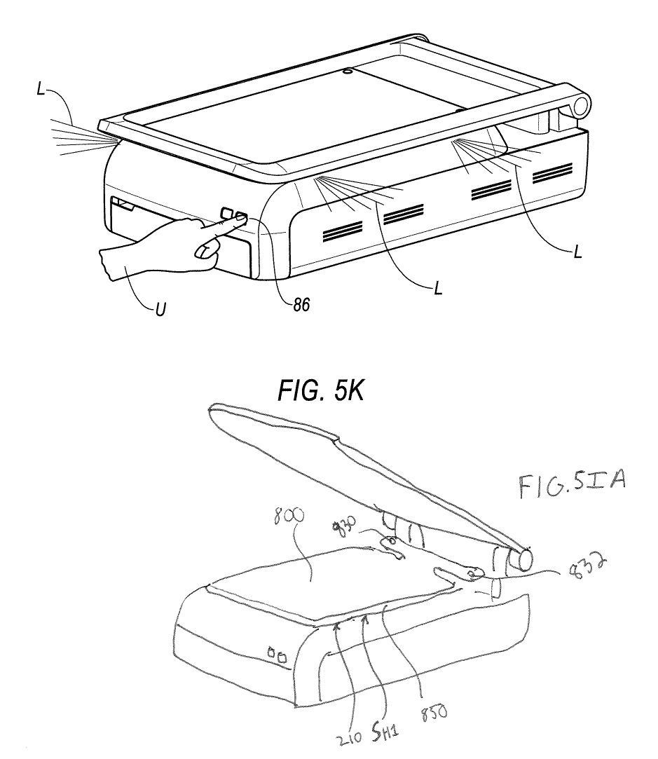

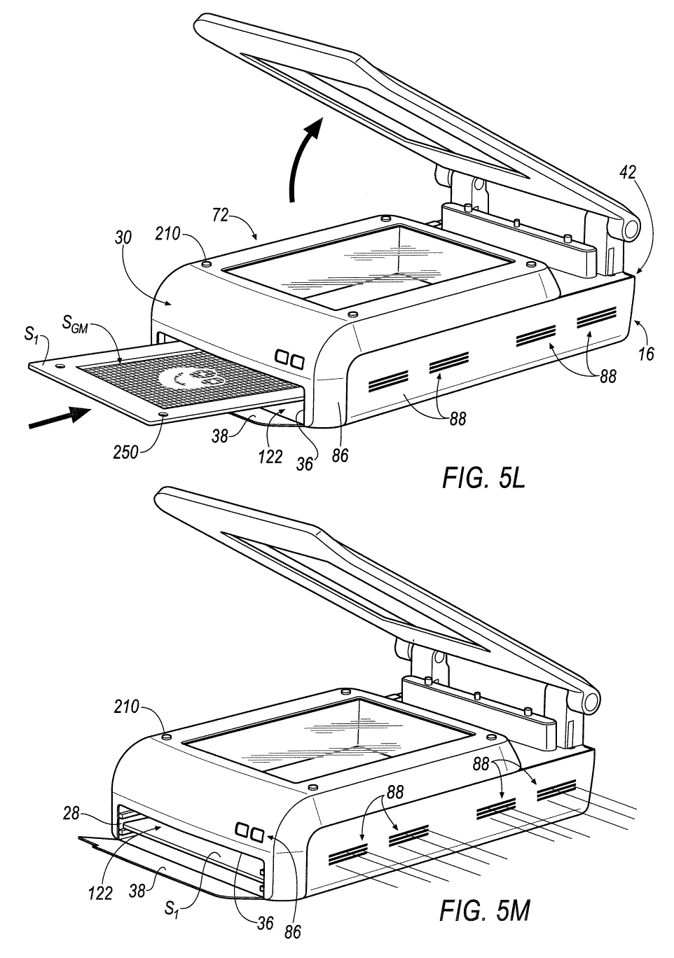

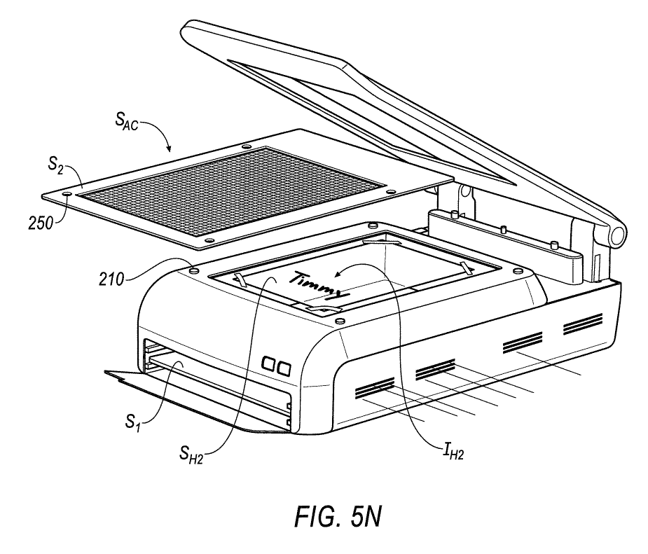

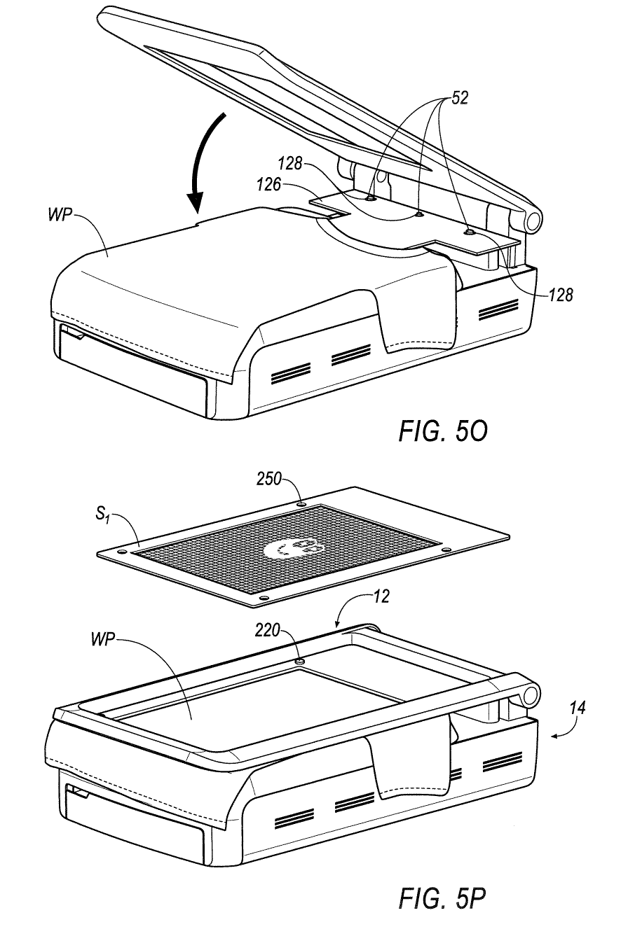

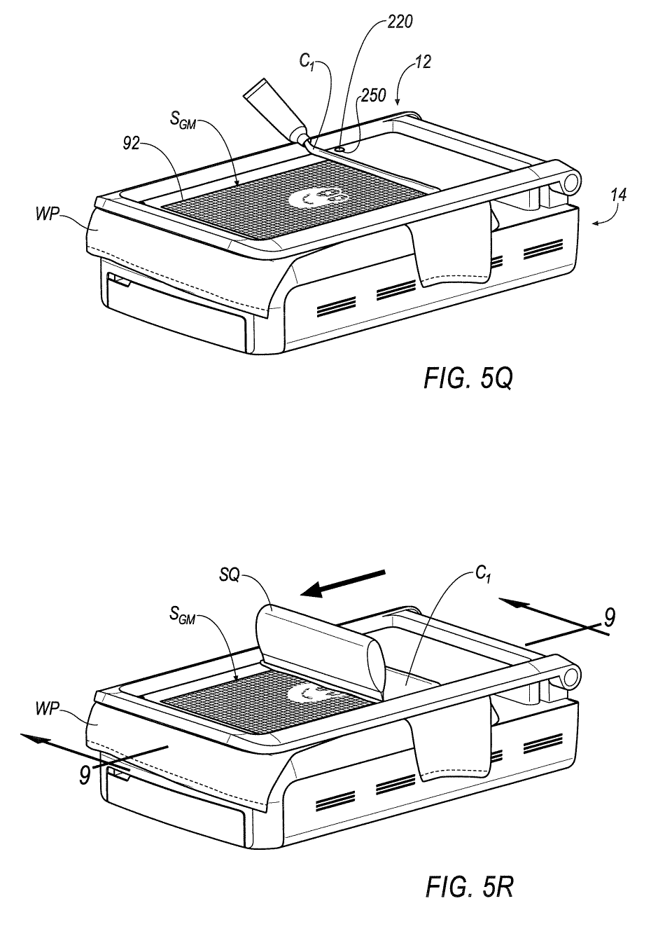

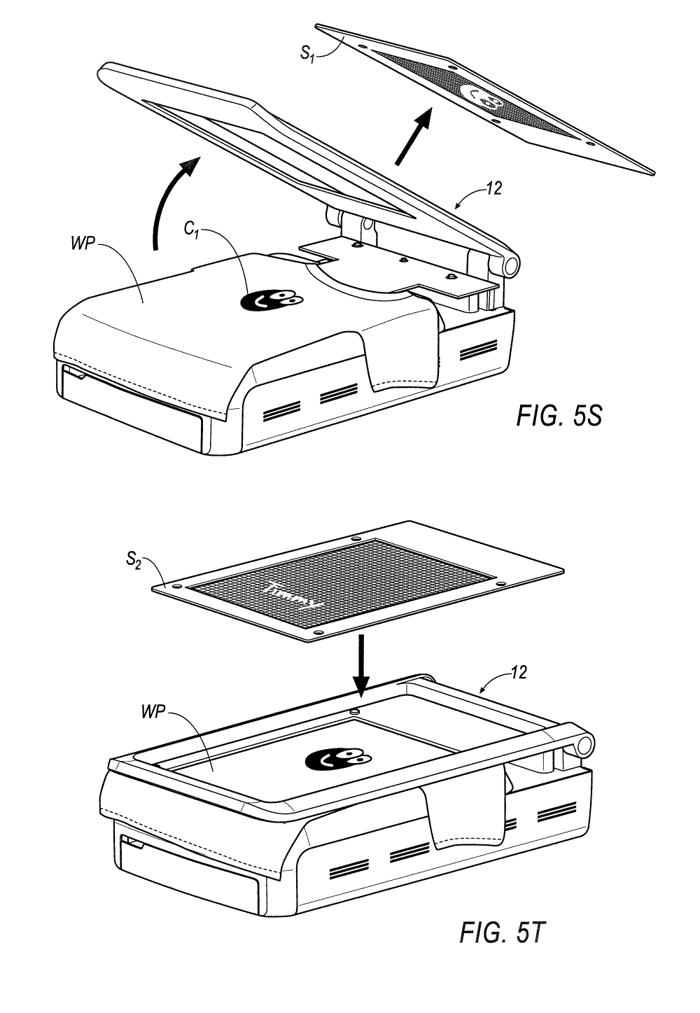

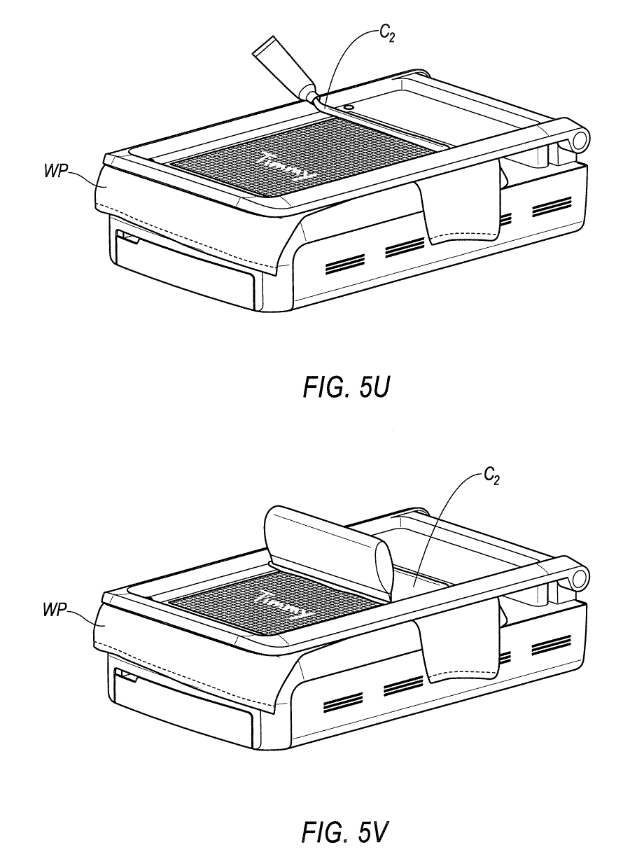

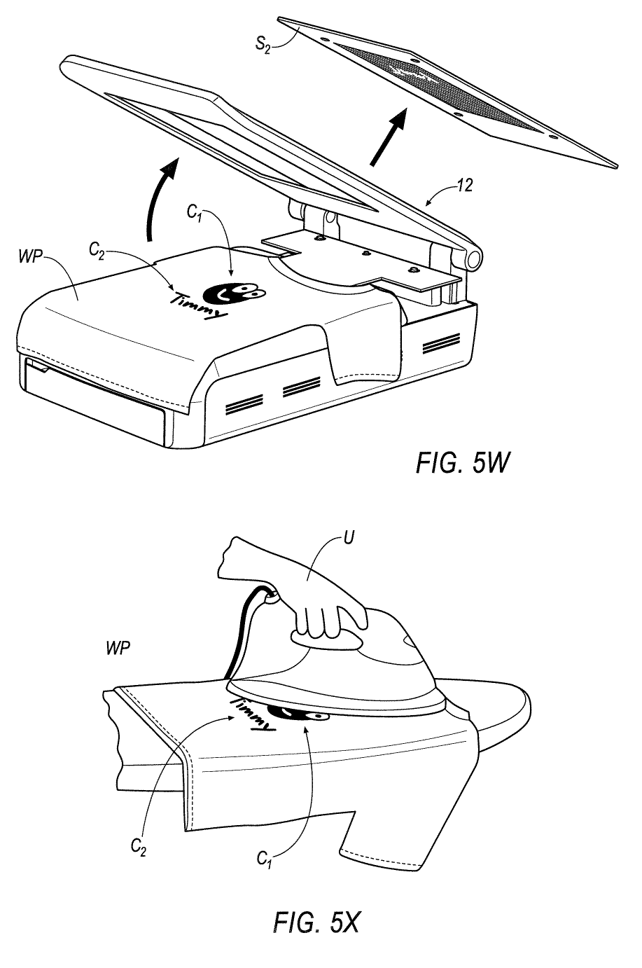

In an embodiment, a screen printer is shown generally at 10 in FIGS. 1-4 and 5G-5W. The screen printer 10 generally includes a cover portion 12 movably-connected to a support portion 14. One or more of the cover portion 12 and support portion 14 retain a screen body, S₁, S₂ (see, e.g., FIGS. 5G-5W). Further, the cover portion 12 and support portion 14 functionally retain the screen body, S₁, S₂, and a workpiece, WP (e.g., a shirt), during a screen printing operation (see, e.g., FIGS. 5P-5W). In general, the screen printer 10 may be utilized to (1) prepare a modified coated grid, S_{GM}, of the screen body, S₁, S₂, (2) dry the modified coated grid, S_{GM}, of the screen body, S₁, S₂), and (3) prepare a work piece, WP, with one or more of a printed/stenciled image, art, lettering, numbering, indicia or the like.

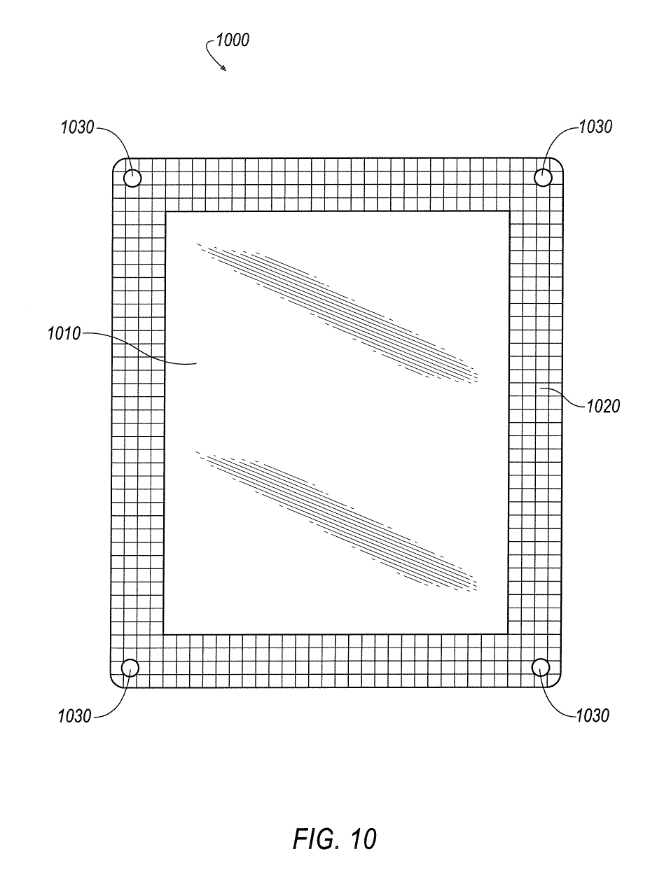

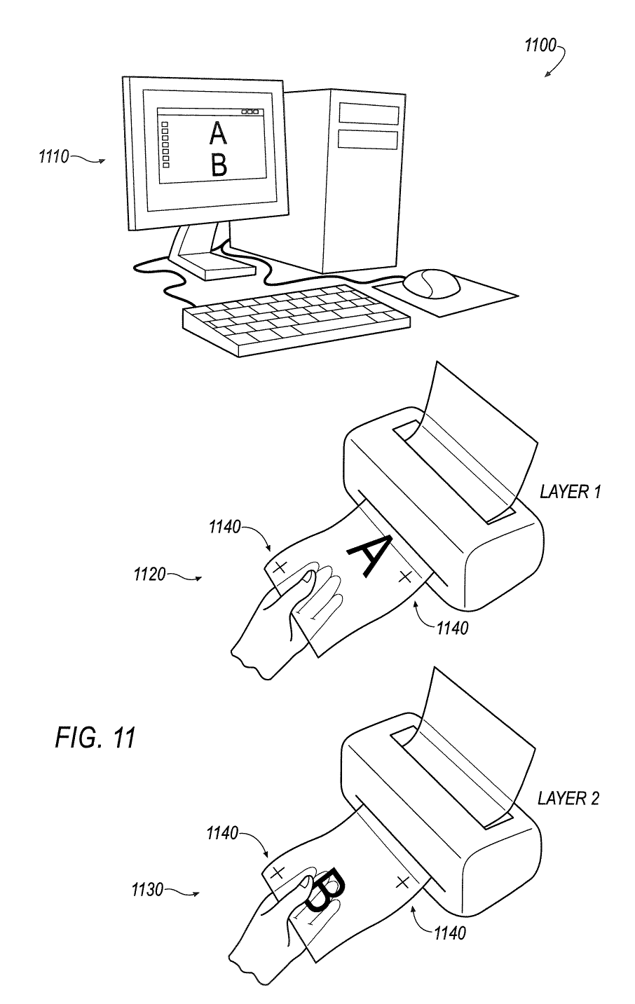

In general, the screen printer 10 may include an upper registration system 220, a lower registration system 210, and a platen registration system 52. Each of the registration systems allow for the accurate creation of screens and printing using the screen printer. For example, the screen may be aligned for exposure using the lower registration system, and then aligned using the upper registration system when printing. The workpiece (e.g., a shirt) may be aligned using a platen mating features for the platen registration system. Additionally, when creating the screen artwork, additional registration systems for the artwork images may use lower registration system for alignment (see FIGS. 10 and 11).

Referring initially to FIG. 1, the support portion 14 includes abuse portion 16 defined by a base member 18 and a pair of opposing side wall members 20a, 20b. In an embodiment, the opposing side wall members 20a, 20b extend substantially perpendicularly from the base member 18.

The base portion 16 may also include a rack member 22. The rack member 22 may include one or more rack sidewalls 24 and one or more cover members 26. The one or more rack sidewalls 24 may extend substantially perpendicularly from the base member 18 and the one or more cover members 26 may extend substantially perpendicularly from the one or more rack sidewalls 24.

The one or more rack sidewalls 24 may include one or more ribs 25. The one or more ribs 25 extend along the length of the one or more rack sidewalls 24. The one or more ribs 25 and one or more rack sidewalls 24 define one or more slots 28. As will be described in the foregoing disclosure, the one or more ribs 25 and slots 28 may be utilized for stowing one or more screen bodies, S₁, S₂, during a drying operation.

In an embodiment, the support portion 14 also includes a front cover portion, which is shown generally at 30. The front cover portion 30 may be a separate component that is attached to a front surface 32 of the base portion 16. Alternatively, the front cover portion 30 may by integrally formed with the base portion 16.

The front cover portion 30 includes a front surface 34 defining an opening 36. A door 38 may be attached to the front cover portion 30 for closing-out the opening 36. The door 38 may be attached to the front cover portion 30 by way of a hinge connection, or, alternatively, in a snap-fit/friction-fit connection.

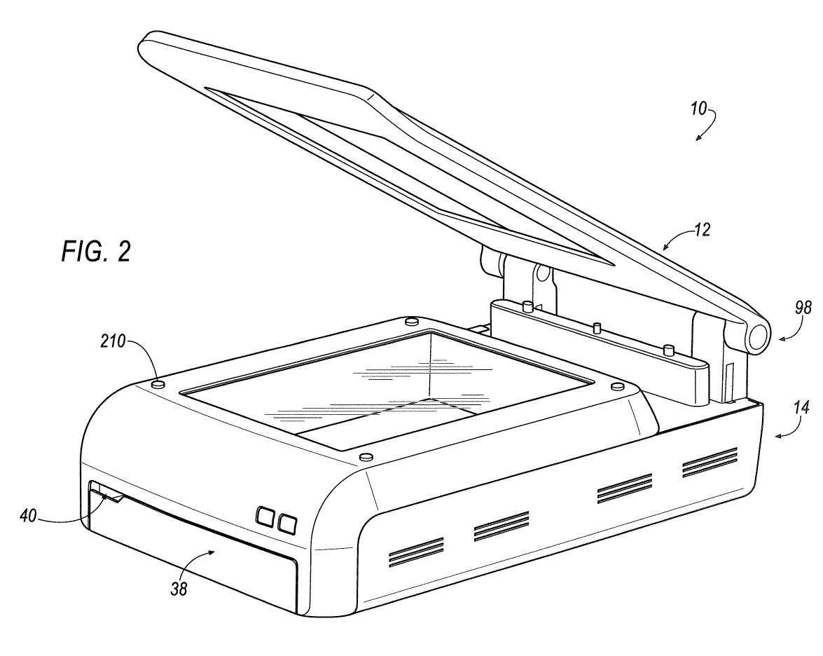

The door 38 is generally defined by a length, L_{D}, and a width, W_{D}. Further, the door 38 may define a recess, which is shown generally at 40. The recess 40 is generally defined by a lesser width, W_{D}′, than the width, W_{D}, for a sub-length, L_{D}′, of the overall length, L_{D}, of the door 38. Referring to FIGS. 2-4, the recess 40 permits, for example, a user's finger to grasp and remove/open the door 38 from/relative the front cover portion 30. Alternatively, recess 40 may be omitted and a push-to-release latch may be added to door 38 to provide a latch. The latch may be configured as a push-to-close, and push-to-release latch system.

Referring to FIG. 1, the support portion 14 also includes a rear cover portion, which is shown generally at 42. The rear cover portion 42 may be a separate component that is attached to a rear surface 44 of the base portion 16. Alternatively, the rear cover portion 42 may by integrally formed with the base portion 16.

The rear cover portion 42 generally defines a rear portion 46 and a flange portion 48 extending substantially perpendicularly from the rear portion 46. A datum registration portion 50 extends substantially perpendicularly from the flange portion 48. A plurality of registration pegs 52 may extend from the datum registration portion 50. The support portion 14 may include one or more adjustable leg portions, which is shown generally at 54. The support portion 14 includes a pair of adjust leg portions 54.

Each adjustable leg portion 54 may be adjustably-disposed in a recessed pocket 56 defined by the rear cover portion 42. Each adjustable leg portion 54 may be disposed in a vertically adjustable position within the recessed pocket 56 to permit vertical adjustment of the cover portion 12 relative the support portion 14 if, for example, a substantially thick work piece, WP, is disposed between the cover portion 12 and support portion 14.

Each adjustable leg portion 54 may include a first member 58 that is removably-attachable to a second member 60. Each of the first and second members 58, 60 define a recess 62, 64, and, when attached together, the recesses 62, 64 define an opening 66. The opening 66 of each adjustable leg portion 54 receives a portion 96 of the cover member 12, as will be described in the foregoing disclosure. The cover member 12 is movably-adjustable relative the support portion 14 at the openings 66.

The support portion 14 also includes an upper cover portion, which is shown generally at 68. In an embodiment, the upper cover portion 68 may be a separate component that is attached to an upper surface 70 of the base portion 16. Alternatively, the upper cover portion 68 may by integrally formed with the base portion 16. The upper cover portion 68 includes a top cover member 72 and a tray member 74 attached to the cover member 72. In an embodiment, the top cover member 72 defines an opening 76. In an embodiment, a transparent member 78, such as, for example, glass or plastic, is disposed in the opening 76 formed in the top cover member 72.

Cover member 72 may also include a portion of a registration system that includes registration points 210 near the corners of cover member 72. The registration points 210 may be simple pegs, or they may be, for example, magnetic to provide holding for an image used to expose a screen (discussed below). The registration points 210 may be included as two (2) registration points, or as shown, four (4) registration points at each corner of cover member 72. Alternatively, there may be a single registration point 210, but that the image may be aligned with a second registration point such as the edge of cover member 72.

Tray member 74 includes a bottom wall 80 and a plurality of sidewalls 82 extending from the bottom wall 80. In an embodiment, the bottom wall 80, plurality of sidewalls 82 and transparent member 78 define a cavity 84. One or more functional buttons 86 may be provided with the screen printer 10. The one or more functional buttons 86 may be disposed upon one or more of the cover portion 12 and the support portion 14. In an embodiment the one or more functional buttons 86 may be disposed upon the front cover portion 30 as shown in FIG. 1.

Depressing one or more of the functional buttons 86 may activate one or more fluorescent light bulbs, B, and one or more fans, F. The one or more fluorescent light bulbs, B, may be disposed in the cavity 84. Note that the bulbs may be bulb-shaped, tubular, or otherwise configured for providing light. Four fluorescent light bulbs, B, may be disposed in the cavity 84. The one or more fans, F, may be disposed substantially adjacent one or more of the side wall members 20a, 20b of the base member 18. The one or more side walls members 20a, 20b may define one or more vented openings 88 to permit the one or more fans, F, to move air from inside the support portion 14 to ambient surrounds.

In an embodiment, the cover portion 12 includes a body portion 90 having a length, L_{C}, and a width, W_{C}. In an embodiment, the length, L_{C}, and width, W_{C}, of the body portion 90 generally defines a substantially rectangular configuration that is substantially the same as the dimensions of the base portion 16 of the support portion 14. In an embodiment, the body portion 90 generally defines an opening 92 defined by a length, L_{O}, and a width, W_{O}.

In an embodiment, the body portion 90 includes a first end 94a and a second end 94b. The second end 94b includes one or more substantially cylindrical portions 96. In an embodiment, each of the one or more substantially cylindrical portions 96 are disposed in the one or more openings 66 that are each defined by the adjustable leg portions 54. The connection of the one or more substantially cylindrical portions 96 and adjustable leg portions 54 generally define a hinge or hinge connection, which is shown generally at 98 in FIGS. 2-4.

Cover portion 12 may also include an upper registration system 220, which may include one or more protrusions allowing for a screen (discussed below) to be registered with cover portion and allows the user to avoid having to make fine alignments. The user would place the screen onto cover portion 12 and easily align the screen with the upper registration system 220. The screen, as discussed below, would include mating elements for upper registration system 220. Such mating elements may include, for example, holes to mate with the protrusions of upper registration system 220.

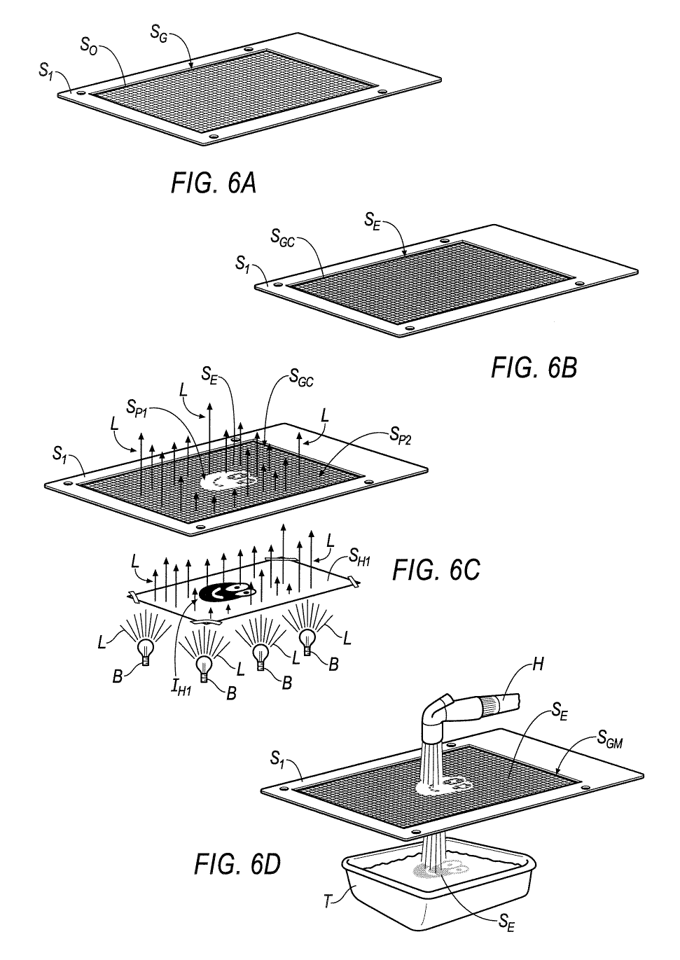

Referring now to FIGS. 5A-5W, one or more methods for using the screen printer 10 is described according to an embodiment. In a first embodiment, the screen printer 10 may be utilized by a user, U, for the purpose of modifying a coated grid, S_{GC} (see, e.g., FIG. 6B), of one or more screen bodies, S, to define a modified coated grid, S_{GM} (see, e.g., FIG. 6C), of the one or more screen bodies, S. In general, the modified coated grid, S_{GM}, defines a stenciled image, art, lettering, numbering, indicia or the like. In another embodiment, the screen printer 10 may be utilized by a user, U, in workpiece silk-screening operation (see, e.g., FIGS. 5P-5W) by interfacing, with the screen printer 10, the one or more screen bodies, S₁, S₂, having the modified coated grid, S_{GM}.

Accordingly, it will be appreciated that the novel usage of the screen printer 10 may permit a user, U, to prepare one or more silk-screened workpieces, WP, in the comfort of their home, office or the like. Further, it will be appreciated, however, that the modifying of a coated grid, S_{GC}, of one or more screen bodies, S₁, S₂, to define a modified coated grid, S_{GM}, may be obviated if, for example, a user, U, obtains or purchases a screen body, S₁, S₂, that already includes a prefabricated modified coated grid, S_{GM}, that defines an a stenciled image, art, lettering, numbering, indicia or the like.

Referring initially to FIGS. 5A and 5B, a computer workstation is shown generally at 100 according to an embodiment. The computer workstation 100 may include one or more of an imaging monitor 102, a hard drive 104, a printer 106 and one or more input devices including, for example, a keyboard 108 and a mouse 110.

In an embodiment, image-editing/preparation software may be installed in the hard drive 104. As seen in FIG. 5A, the user, U, may access the software and prepare a digital representation of one or more of an image, art, lettering, numbering, indicia or the like, which is displayed generally at I_{D} on the imaging monitor 102. As seen in FIGS. 5C-5E, the user, U, may prepare more than one digital representation of image, art, lettering, numbering, indicia or the like, which is shown generally at I_{D1}, I_{D2}.

As seen in FIG. 5C, for example, a user, U, may prepare a first digital representation, I_{D1}, resembling, for example, a face of a cartoon character that is positioned in a substantially upper-central position on the monitor 102. The monitor 102 may also display a toolbar/grid that notifies the user, U, the location where the first digital representation, I_{D1}, will appear on a hardcopy sheet of material, S_{H} (see, e.g., FIG. 5B). Then, as seen in FIG. 5D, the user, U, may prepare a second digital representation, I_{D2}, resembling, for example, the text “Timmy,” that is to be positioned below the first digital representation, I_{D1}, at a substantially lower central position on the monitor 102.

The user, U, may desire to dispose a physical representation of the first digital representation, I_{D1}, in a first color on the workpiece, WP, and a physical representation of the second digital representation, I_{D2}, in a second color on the work piece, WP, that is different from the first color. Accordingly, the user, U, may prepare first and second screen bodies, S₁, S₂ (see, e.g., FIGS. 5H and 5N) that each define a uniquely modified coated grid, S_{GM} (i.e., the first screen body, S₁, includes a modified coated grid, S_{GM}, defining the first digital representation, I_{D1}, of the face of a cartoon character and the second screen body, S₂, includes a modified coated grid, S_{GM}, defining the second digital representation, I_{D2}, of the word “Timmy”).

Accordingly, in view of the potential that more than one color may be desired by a user, U, when “silk screening” a final image to be disposed on the work piece, WP, the software may be programmed to query the user, U, of the desired color for each digital representations, I_{D1}, I_{D2}. If, for example, different colors are selected by the user, U, for each digital representations, I_{D1}, I_{D2}, a digital representation having previously-selected, different color may appear in phantom on the monitor 102 (see, e.g., FIG. 5D) such that the user, U, may have a frame of reference as to the location where the each digital representation, I_{D}, will appear on a hardcopy sheet of material, S_{H}, when more than one screen bodies, S₁, S₂, are to be prepared.

It will be appreciated that if for example, a user, U, desires to prepare the first and second digital representations, I_{D1}, I_{D2}, in the same color, the use of a phantom imaging step in the software may be obviated. In the method described in the foregoing disclosure, the first digital representation, I_{D1}, is to be prepared in a first color and the second digital representation, I_{D2}, is to be prepared in a second color different from the first color; accordingly, the foregoing method will describe the preparation of a first screen body, S₁, and a second screen body, S₂, each defining a unique, first modified coated grid, S_{GM1}, and a unique, second modified coated grid, S_{GM2}.

As seen in FIG. 5B, upon selecting a print function, one or more digital representations, I_{D1}, sharing a similarly selected color is prepared by the printer 106, on a sheet of material, S_{H}, to provide a hardcopy image, I_{H}, of the one or more digital representation, I_{D1}, sharing a similarly selected color. The sheet of material, S_{H}, may include, for example, a substantially transparent sheet of material. The hardcopy image, I_{H}, generally defines a non-transparent portion of the substantially transparent sheet of material, S_{H}. Although steps for preparing the hardcopy image, I_{H}, is described above, it will be appreciated that the steps described in FIGS. 5A-5E may be obviated if for example, the hardcopy image, I_{H}, is prefabricated on a sheet of material, S_{H}, and that is otherwise obtained or purchased by the user, U.

Once the hardcopy image, I_{H}, on the sheet of material, S_{H}, is printed, obtained, purchased or the like (see FIG. 5B), the sheet of material, S_{H}, is then secured to a first panel S_{H1} (see, e.g., FIG. 5F). In an embodiment, as seen in FIG. 5F, the sheet of material is hereinafter referred to as a first sheet of material, S_{H1}, defining a first hardcopy image, I_{H1}. As illustrated, first sheet of material, S_{H1}, is secured to the transparent member 78 with a means for securing, which is shown generally at 112.

As seen in FIG. 5F, the means for securing 112 includes one or more pieces of tape. In an embodiment the one or more pieces of tape 112 may be transparent. Alternatively, other attachment or securing means may be used, such as double-sided tape, Velcro, etc. The means for securing 112 may include one or more clips. In an embodiment, the one or more clips 112 may be formed integrally with first sheet of material, S_{H1}. In an embodiment, the one or more clips 112 may be removably-secured to first sheet of material, S_{H1}. In an embodiment, the one or more clips 112 may include, for example, a synthetic resin (e.g., plastic) material. In an embodiment, the one or more clips 112 may include a transparent material.

Referring to FIG. 5G, the first sheet of material, S_{H1}, is secured to transparent member 78. Alternatively, as described below with respect to FIG. 10, a registration panel may also be used with transparent member 78 to align the images.

Referring to FIG. 5H, the first panel, S₁, is placed adjacent the transparent member 78 of the cover member 72. The one or more passages 250 are aligned with the registration pegs 210. When the first sheet of material, S_{H1}, is placed adjacent the transparent member 78 as described above, a first screen body, S₁, is placed adjacent the first sheet of material, S_{H1}. In an embodiment, the first screen body, S₁, generally defines a frame portion, S_{F}, defining a plurality of passages 250 that are aligned with and receive the registration pegs 210. In general, first screen body, S₁, may be registered with the screen printer by way of the lower registration system, including pegs 210 and holes 250. Using the lower registration system, the first screen body, S₁, is registered to the precise location with respect to the screen printer, and later when used for screening, will be similarly registered with the screen printer using the upper registration system (e.g., 220, 250).

Further, in an embodiment, the first screen body, S₁, generally defines a grid portion, S_{G} (see also, e.g., FIG. 6A) that is coated with an emulsion solution, S_{E} (see also, e.g., FIG. 6B), to generally define the coated grid, S_{GC}. The grid portion, S_{G}, may include a plurality of substantially rigid wires, strings or the like arranged in columns and rows that are secured to an inner periphery of the frame portion, S_{F}, that defines an opening, S_{O}, formed in the first screen body, S₁. As described in the foregoing disclosure, upon exposing the coated grid, S_{GC}, to fluorescent light, L (see, e.g., FIG. 6C), and later subjecting the coated grid to a liquid (see, e.g., FIG. 6D), such as, for example, water, a portion of the emulsion solution, S_{E}, may be washed away or otherwise removed from the grid portion, S_{G}, to generally define the modified coated grid, S_{GM}, defining a stencil.

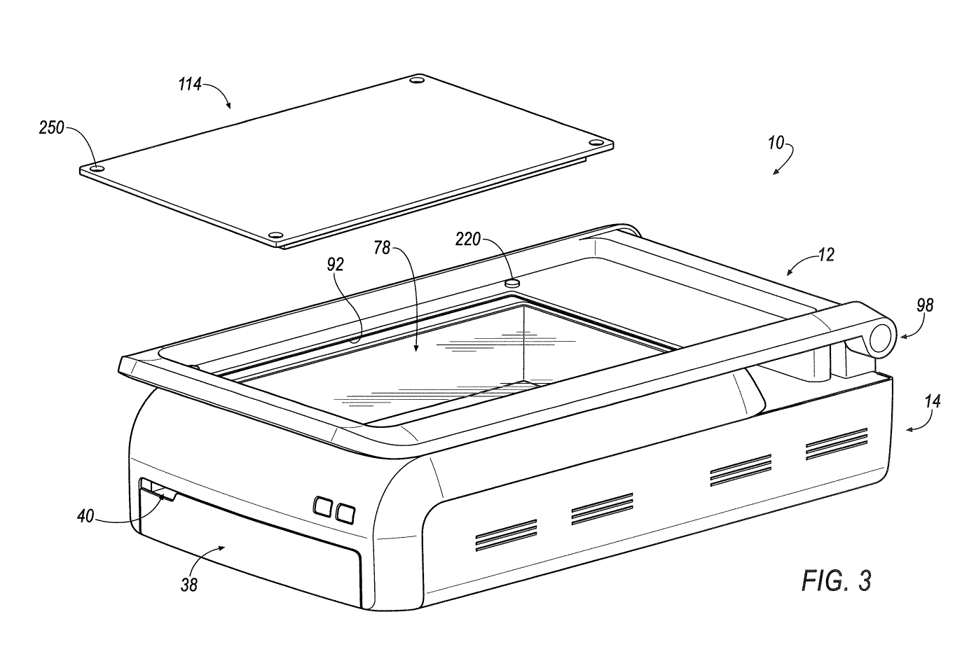

As seen in FIG. 5I, with the cover portion 12 located in an open position, a pressure panel 114 is removably-secured to a lower surface 116 of the cover portion 12. Pressure panel may further include holes 250 for registration and/or retention with upper registration system 220 (see FIGS. 1 and 3). The opening 92 formed by the cover portion 12 is generally closed out when the pressure panel 114 is secured to the lower surface 116 of the cover portion 12. Moreover, pressure panel 114 may include holes 250 to receive the upper registration system 220 pegs. This may allow for pressure panel 114 to be placed on cover portion 12 without sliding out with some changes to the angle of cover portion 12 (e.g., partially opening).

The pressure panel 114 may be secured to the lower surface 116 of the cover portion 12 by way of the upper registration system or may be secured to the lower surface 116 of the pressure panel 114 by way of one or more track members 120 extending from the lower surface 116 of the cover portion 12. The one or more track members 120 may generally define a pair of track members 120 arranged in a parallel relationship, or, alternatively a single track member 120 arranged in a C- or U-shaped relationship. Note that the pressure panel 114 is not necessary to the operation of the screen printer, and may be omitted. Moreover, the user may use other means to create a downward pressure other than pressure panel 114.

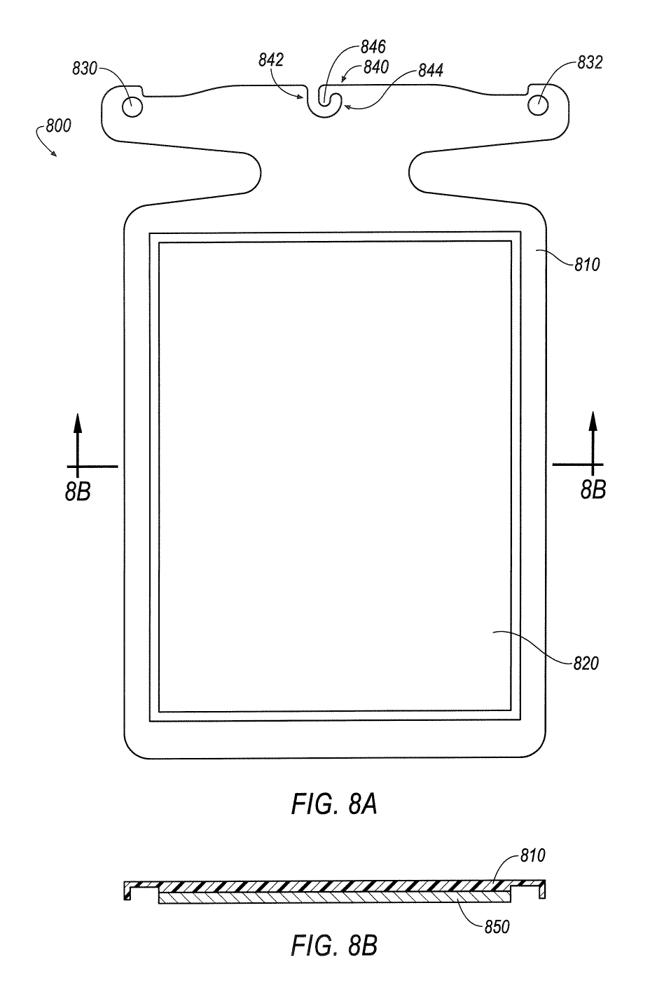

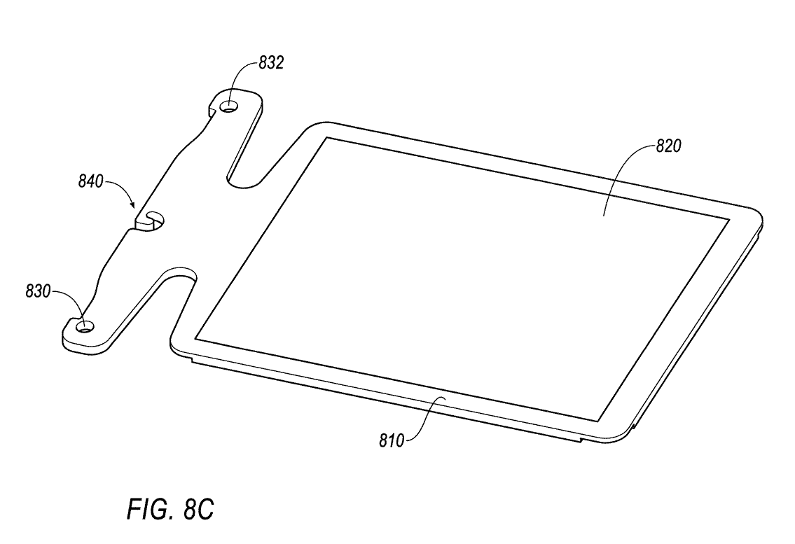

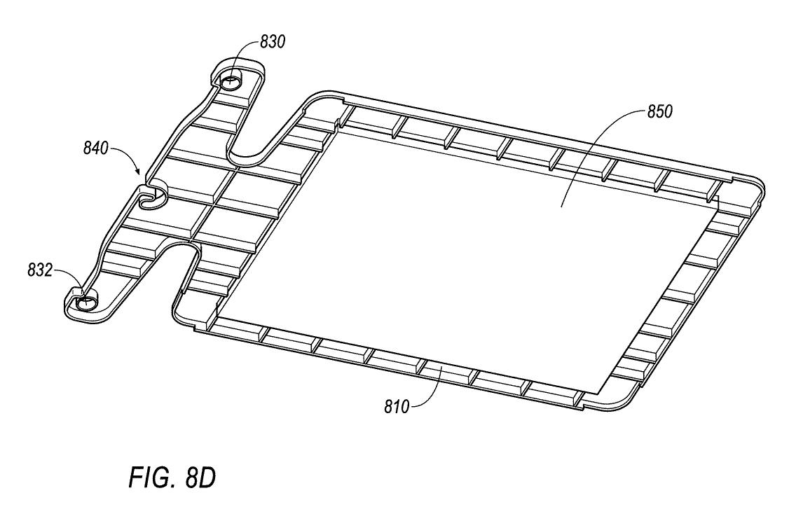

As seen in FIG. 5IA, an alternative method to apply pressure may include use of the platen 800 (see FIGS. 8A and 8B). Rather than using a pressure panel 114, the platen may include a cushion portion 850 that may urge the first sheet of material, S_{H1} against the first screen body, S₁, to relieve any spacing that may otherwise be permitted between the first sheet of material, S_{H1}, and the first screen body, S₁. In use, the user may place platen 800 in place, and close cover portion 12 to apply pressure. Alternatively, the user may also manually add weight to platen 800 to provide additional pressure. In another embodiment, the platen 800 may include additional weight that may include heavy material from manufacturing, or weights added to the platen to increase the mass. In this way, the platen may function to press first sheet of material, S_{H1}, against the first screen body, S₁, during exposure to the light. Moreover, the platen registration system allows for reduced movement of the components and thus, an improved image transferred to the first screen body, S₁. As discussed herein, use of a pressure panel, such as is described with respect to pressure panel 114, may also be considered use of platen 800.

Alternatively, cover member 72 may also include magnets for holding first screen body, S₁, against first sheet of material, S_{H1}. For example, where first screen body, S₁, includes a metallic frame, magnets placed under the surface (or at the surface) of cover member 72 may attract the metallic frame and sandwich first screen body, S₁, and first sheet of material, S_{H1} against cover member 72. As discussed herein, each of the pressure panel, the platen, and/or the magnets may be used alone, in conjunction with each other, or not at all to provide that the first screen body, S₁, is held in position with first sheet of material, S_{H1}, for exposure.

As seen in FIG. 5J, once the pressure panel 114 is disposed adjacent the lower surface 116 of the cover portion 12, the cover portion 12 is moved from the open position to a closed position, as seen in FIG. 5K. Functionally, once the cover portion 12 is moved to the closed position, the pressure panel 114 urges the first sheet of material, S_{H1}, against the first screen body, S₁, to relieve any spacing that may otherwise be permitted between the first sheet of material, S_{H1}, and the first screen body, S₁.

As seen in FIG. 5K, once the cover portion 12 is moved to the closed position, the user, U, may depress one or more of the functional buttons 86 to activate one or more fluorescent light bulbs, B. Activation of one or more of the fluorescent bulbs, B, is shown generally by star-bursts, L, which generally indicate that the one or more fluorescent bulbs, B, are producing fluorescent light. In an embodiment, the silk screen 10 may include electronics, such as, for example, a timer (not shown) that may automatically deactivate the one or more fluorescent bulbs, B, once a period of time has surpassed, or, alternatively, in an embodiment, the user, U, may press one or more of the functional buttons 86 to manually deactivate the one or more fluorescent bulbs, B.

As seen generally in FIG. 6C, activation of the one or more fluorescent bulbs, B, results in the fluorescent light, L, being directed through the transparent member 78 and the first sheet of material, S_{H1}, including the non-transparent first hardcopy image, I_{H1}. Functionally, the non-transparent first hardcopy image, I_{H1}, prevents the fluorescent light, L, from reaching a portion, S_{P1}, of the coated grid, S_{GC}, as the transparency of the panel, P, and the first sheet of material, S_{H1}, permit the fluorescent light, L, to reach the remaining portion, S_{P2}, of the coated grid, S_{GC}. Upon exposing the fluorescent light, L, to the emulsion solution, S_{E}, disposed upon the grid portion, S_{G}, the portion, S_{P2}, of the coated grid, S_{GC}, that is not obscured by the first hardcopy image, I_{H1}, results in the non-obscured portion, S_{P2}, of the coated grid, S_{GC}, changing from a non-hardened composition to a hardened composition. Moreover, in use, the non-hardened composition will be washed away and become permeable to the ink when screen printing.

Referring to FIG. 6D, when a liquid, such as, for example, water, comes into contact with the non-obscured portion, S_{P2}, of the coated grid, S_{GC} the liquid will not result in the loss of the emulsion solution, S_{E}, from the grid portion, S_{G}, that was exposed to the fluorescent light, L. Conversely, when the liquid comes into contact with the obscured portion, S_{P1}, of the coated grid, S_{GC}, as defined by the first hardcopy image, I_{H1}, the liquid will result in the loss of the emulsion solution, S_{E}, from the grid portion, S_{G}, that was not exposed to the fluorescent light, L, to define the modified coated grid, S_{GM}. The liquid may be provided from a spray hose, H, of a kitchen faucet, and a tray, T, basin or the like may be disposed underneath the first screen body, S₁, for catching the liquid and the emulsion solution, S_{E}, that is removed from the grid portion, S_{G}.

Referring to FIG. 5L, once the modified coated grid, S_{GM}, has been prepared, the first screen body, S₁, may be placed within a drying compartment, which is shown generally at 122. Drying compartment 122 is a cavity defined by the base portion 16, front cover portion 30, rear cover portion 42 and top cover member 72. Access to the drying compartment 122 is permitted by way of the opening 36 defined by the front cover portion 30 upon removing/opening the door 38.

As seen in FIG. 5M, the drying compartment 122 removes any liquid from the first screen body, S₁, as a result of the preparation of the modified coated grid, S_{GM}, described in FIGS. 6C and 6D. The first screen body, S₁, having the modified coated grid, S_{GM}, is inserted through the opening 36 and retained within the one or more slots 28. Once inserted into the drying compartment 122, the user presses the one or more functional button 86 to activate the fans, F. The fans, F, move air within and out of the drying compartment though the opening 36 and/or the one or more vented openings 88.

Referring to FIG. 5N, before, during or after the drying operation of the first screen body, S₁, that is described above, the user, U, may place a second panel, P₂, adjacent the transparent member 78. As illustrated, the second panel, P₂, secures a second sheet of material, S_{H2}, defining a second hardcopy image, I_{H2}. Further, a second screen body, S₂, including coated grid, S_{GC}, is disposed adjacent the second panel, P₂, and the process described above in FIGS. 5H-5K is repeated to prepare a modified coated grid, S_{GM}, carried by the second screen body, S₂. Once the modified coated grid, S_{GM}, carried by the second screen body, S₂, has been prepared, the second screen body, S₂, may be disposed within the drying compartment 122 for removing the liquid from the second screen body, S₂.

Referring to FIG. 5O, once the first screen body, S₁, has been dried, the pressure panel 114 is removed from the lower surface 116 of the cover portion 12. A work piece, WP, such as, for example, a shirt, is arranged on or secured to a support member 126. Support member 126 which may then be secured to the screen printer. Support member 126 may include a plurality of passages 128 that are aligned with and receive the plurality of registration pegs 52. In this way, support member 126 is aligned with the screen printer by way of the platen registration system, and the screen will be further aligned using the upper registration system.

Referring to FIG. 5P, the first screen body, S₁, may be secured to the lower surface 116 of the cover portion 12 by one the upper registration system (e.g., 220, 250) and/or the one or more track members 120. The work piece, WP, and support member 126 may be arranged substantially adjacent the top cover member 72.

Then, as seen in FIG. 5Q, the cover portion 12 is moved from the open position to the closed position such that the work piece, WP, is secured by/between the cover portion 12 and the support portion 14. The opening 92 exposes the modified coated grid, S_{GM}, carried by the first screen body, S₁.

Once the modified coated grid, S_{GM}, carried by the first screen body, S₁, is arranged within and exposed by the opening 92, the user, U, may dispose an ink, dye or the like, which is shown generally at C1 upon the modified coated grid, S_{GM}. The ink, dye or the like, C1, is defined by the first color.

As seen in FIG. 5R, the user, U, may obtain a squeegee, SQ, or the like and spread the ink, dye or the like, C1, over a surface area defined by the modified coated grid, S_{GM}, at least proximate the location where the emulsion solution, S_{E}, has been removed from the grid portion, S_{G}. It will be appreciated that movement of the ink, dye or the like, C1, proximate the location where the emulsion solution, S_{E}, has been removed from the grid portion, S_{G}, results in the ink, dye or the like, C1, moving through the modified coated grid, S_{GM}, such that the ink, dye or the like, C1, may be stenciled/deposited upon the work piece, WP.

Referring to FIG. 53, once the ink, dye or the like, C1, has been spread over the surface area defined by the modified coated grid, S_{GM}, at least proximate the location where the emulsion solution, S_{E}, has been removed, the user, U, may move the cover portion 12 from the closed position to the opened position to expose the work piece, WP, that includes a physical representation of the first hardcopy image, I_{H1}, in the first color, C1, as a result of the ink, dye or like, C1, being moved through the modified coated grid, S_{GM}, and stenciled/deposited upon the work piece, WP.

If the user, U, is satisfied with the appearance of the representation of the first hardcopy image, I_{H1}, on the work piece, WP, then, as seen in FIG. 5S, the first screen body, S₁, may be removed from the cover portion 12 so that the second screen body, S₂, may be secured to the cover portion 12 as seen in FIG. 5T. With the second screen body, S₂, secured to the cover portion 12, the above-described process is repeated with the exception that the ink, dye or the like, which is shown generally at C2 in FIGS. 5U-5V includes the second color that is different from the first color.

Referring to FIG. 5W, the cover portion 12 is moved from the closed position to the open position to expose the work piece, WP, that also includes a physical representation of the second hardcopy image, I_{H2}, in the second color, C2 as a result of the ink, dye or the like, C2, being moved through the modified coated grid, S_{GM}, of the second screen body, S₂. Subsequently, as seen in FIG. 5X, the work piece, WP, may be removed from the support member 126 such that the work piece, WP, may be ironed to retain the ink, dye or the like, C1, C2 to the work piece, WP.

Upon finishing the stenciling/application of the first and second inks, dyes or the like, C1, C2, to the work piece, WP, the first and second screen bodies, S₁, S₂, may be rinsed to remove residual ink, dye or the like. Further, if the user, U, wishes to create a new silk screen designs for a work piece, WP, shirt or the like, the user, U, may soak the one or more screen bodies, S₁, S₂, in a bath of solution, such as, for example, alcohol, to remove the emulsion solution, S_{E}, from the grid portion, S_{G}; once the emulsion solution, S_{E}, is removed from the grid portion, S_{G}, the user, U, may coat the grid portion, S_{G}, with a fresh layer of emulsion solution, S_{E}, to define a newly coated grid, S_{GC}, for later modification with anew design to be prepared on the computer workstation 100.

Accordingly, in a commercial embodiment, the screen printer 10 may be sold alone, or, alternatively, as a kit. In an example, the kit may include one or more of the following: imaging software for the computer workstation 100, one or more screen bodies, S₁, S₂, one or more units of emulsion solution, S_{E}, one or more units of ink, dye or the like, C1, C2, and one or more units of emulsion-removing solution. The kit may be sold alone with the screen printer 10, or, alternatively, in an embodiment, individual portions of the kit may be sold (i.e., if a user depletes his/her supply of ink, emulsion solution, or the like, the user, U, may purchase individual bottles of the ink, emulsion solution or the like).

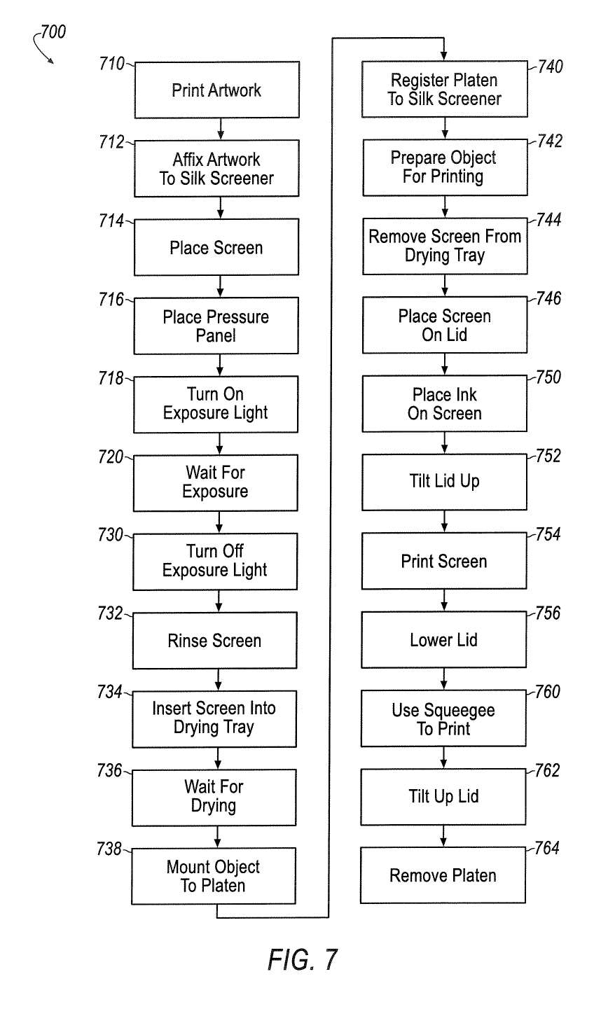

FIG. 7 is an example of a method 700 for silk screening. The method may be used with the screen printer as described herein.

In step 710, the user may print artwork. The artwork may be printed, for example, on a substantially transparent sheet of material (see S_{H}, for example, of FIG. 5B).

In step 712, the artwork is affixed to the screen printer. For example, the artwork may be placed in registration with a registration panel (see FIG. 10) for alignment. The registration panel allows multiple images to be mapped to screens while maintaining alignment for an overall multi-color or multi-pass design to be printed. The artwork may be, for example, taped directly to transparent member 78 (see FIG. 1). Alternatively, the substantially transparent sheet of material having the artwork may be taped to the registration panel (which may be affixed to transparent member 78) or registration pegs 210.

In step 714, the screen S (see FIG. 5H) placed may be placed over the artwork. The screen may be a reusable screen or a single-use screen. With a reusable screen, the screen may be cleaned and then reconfigured with emulsion. For example, an emulsion (e.g., a blockout material) may be removed from a screen that has already been used. In this example, an emulsion remover may be used to dissolve the emulsion from the screen. After the existing emulsion is removed, new emulsion may be applied in liquid form or using an emulsion sheet. The emulsion sheets may be easy for the user to apply and also provide consistent coverage of the screen.

Applying an emulsion sheet to the screen may be a user operation that starts with removing the emulsion sheet from an opaque plastic bag (used for transport and storage) in a dimly lit area. The user may then wet the screen and apply the dull/sticky side of the emulsion sheet to the back of the wet screen. Before drying, the user may position the emulsion sheet to the center of the screen for full coverage. The user may then run a squeegee over the shiny surface of the emulsion (opposite the screen). The user may then inspect the emulsion and screen for imperfections (bubbles or dry areas). To correct imperfections, addition of water may allow the areas to correct themselves (e.g., bonding to the screen in the case of dry areas). Then the user may use the squeegee to remove bubbles and from both sides of the screen to remove excess water prior to drying.

The renewed screen may then be dried in open air, or by use of the drying system associated with the screen printer as discussed herein. For example, the screen may be placed in the drying rack (see FIG. 1, ribs 25 and slots 28) define one or more slots 28 for about twenty (20) minutes during a drying operation. Of course, depending on the environment (e.g., humidity and temperature) that the screen printer is used in, the drying operation may take more or less time than recommended. Alternatively, a heat-gun or hair-dryer may be used to accelerate the drying process. Also, the door 38 may be left open to provide additional airflow for the drying process. After drying, the screen is now ready for use.

In step 716, a pressure panel 114 (see FIGS. 5I and 5J) may be placed over the sandwich of the artwork and screen. Use of the pressure panel may be desirable to provide contact or near contact of the artwork and screen to provide crisp edges when an emulsion on the screen is exposed with light.

In step 718, an exposure light may be turned on (see, e.g., FIGS. 5K and 6C). The lighting may be housed within the screen printer and may use fluorescent light bulbs or a light source that is tuned to the characteristics of the emulsion on the screen.

In step 720, the user waits the recommended exposure time based on the light source used and the sensitivity of the emulsion.

In step 730, the exposure light is turned off.

In step 732, the screen is rinsed (see, e.g., FIG. 6D). The rinsing process may wash away the non-exposed portion of the emulsion that was blocked by the artwork. The remaining emulsion would be the negative image of the artworks, substantially preventing ink from penetrating the screen during printing.

In step 734, the screen may be inserted into the drawing tray (see, e.g., FIG. 5L).

In step 736, the drying mechanism (e.g., a fan or heater) may be turned on and the user may wait for a recommended time until the screen is dry.

In step 738, an object for printing (e.g., a shirt) may be mounted to the platen (see, e.g., FIG. 5O).

In step 740, the platen may be registered with the screen printer (e.g., see FIG. 5O). The registration may use one or more registration passages 128 that are aligned with and receive the plurality of registration pegs 52.

In step 742, the object is prepared for printing. This may include, for example, removing wrinkles to allow for smooth and consistent printing.

In step 744, the screen may be removed from the drying tray. This step may be performed at any time, but preferably, after the recommended drying time has elapsed. Drying may also be accomplished with open-air drying.

In step 746, the screen is placed on the lid (see FIG. 5P).

In step 750, the lid may be tilted upwardly.

In step 752, the ink may be placed on the screen (see FIG. 5Q). In an example, the ink may be placed on the screen. Note also that the ink may be placed on the screen in a lowered position, possibly if priming is not desired.

In step 754, The priming step may include moving the ink across the screen with the squeegee to provide a good first print.

In step 756, the lid and screen may be lowered onto the object to be printed.

In step 760, the printing may occur by using the squeegee to pull the ink across the screen, and where the screen is open, the ink will move through the screen and print upon the object.

In step 762, the lid may be tilted up.

In step 764, the platen may be removed, for example, for drying or ironing to fix the ink design onto the object.

In all, the process as described herein may be modified by the user, in order of steps as well as addition or omission of steps. Thus, the process may be tailored to the user's needs and desires. The process may also be repeated where multi-color or multi-pass images are to be printed. In these cases, for example, the screens may be prepared in advance of the printing steps (see, e.g., FIGS. 5A-5X).

FIGS. 8A through 8D show a platen 800 for use with the screen printer. Platen 800 may include a body portion 810, an object retention portion 820, registration holes 830, 832, and an integrated hanger 840. Integrated hanger 840 allows the user to print a design (or print multiple designs) and the object may be hung up to dry without disturbing the net printed image. This may be helpful, for example, when an intricate design has been printed that may be damaged by handling. It may also be helpful to allow for ease of printing when multiple platens are used, multiple objects may be printed and hung-dry without requiring the need for horizontal drying (e.g., laying on a table). In general, integrated hanger 840 allows for the removal of the object and platen from the screen printing machine while also providing that the printed object is not disturbed while drying.

Integrated hanger 840 may be configured as a hole, as the end of a coat hanger, etc. As shown, integrated hanger 840 includes an opening channel 842, a hanging position 844, and a retainer bump 846. Opening channel 842 provides that the user can slip platen 800 over, for example a clothes line or the lower bar of a coat hanger, etc. When the clothes line is alighted with hanging position 844, the user may let go and gravity will allow platen 800 to remained positioned on the line because retainer bump 846 substantially prevents some axial movement from (or slippage) from moving the line out of hanging position 844 to opening channel 842.

Body portion 810 may also include a sticky mat 820 that assists in maintaining the object's position on platen 800 during the screen printing process. For example, when pressure is placed on screen (typically in direct contact with the object), the object has a tendency to move or creep in the direction of the squeegee stroke. However, sticky mat 820 may provide that once the object is placed in contact with sticky mat 820, it will not substantially move during the printing process. Moreover, when pressure is placed upon the object, the force may provide that the object is more firmly secured to sticky mat 820 and less likely to move. Sticky mat 820 may be provided with platen 800, or it may be an addition to platen 800. Moreover, sticky mat 820 may be a replaceable item.

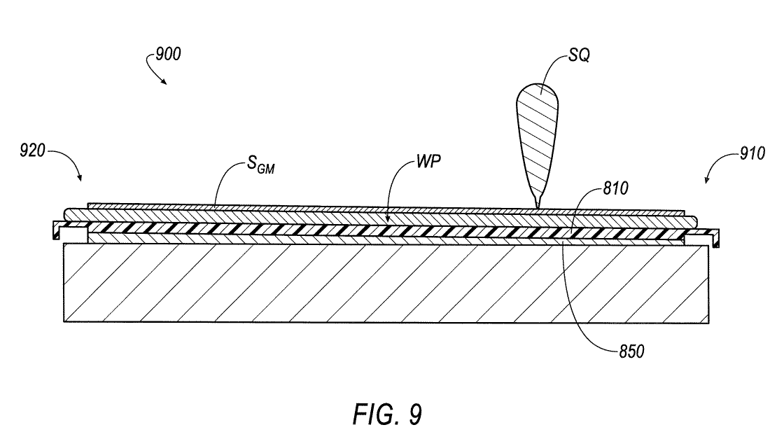

FIG. 8B is a cross-sectional view of a the platen of FIG. 8A. Body portion 810 provides a substantially rigid surface for the object to rest upon when printing is performed. However, under body portion 810, a cushion portion 850 provides for some movement of platen 800 during the printing process. Due to the pressure that may be applied using the squeegee, cushion portion 850 provides a compressible medium to allow the squeegee to push ink through the screen more efficiently (see also FIG. 9). Moreover, cushion portion 850 provides a compressible adjustment mechanism allowing for misalignment of the lid to the platen. By allowing compressibility under platen 800, the lid may be closed to a position that may not be precisely parallel with the base portion 16. However, the compression of cushion portion 850 allows the workpiece to conform to a position substantially parallel to the lid.

FIG. 8D is a bottom perspective view of a the platen of FIG. 8A. Body portion 810 may have cross-bracing on the back side allowing for greater rigidity. As shown, the cross bracing may be molded into body portion 810, when body portion 810 is manufactured as a single piece of plastic. Moreover, cushion portion 850 may extend over the entire bottom surface of platen 800, or it may extend under a substantial portion (as shown) of platen 800.

FIG. 9 is a cross-sectional view 900 of the platen in use. When pressure is applied at the point shown under squeegee SQ, cushion portion 850 may be more compressed (shown as thinner region near 910) than another portion that is not under pressure (shown as thicker portion near 920). The workpiece WP may be positioned between screen S_{GM} when printing is performed.

FIG. 10 is a top view of a registration panel 1000 for use with the screen printer. The substantially transparent registration panel 1000 fits on the screen printer to provide simple and precise registration. The printed grid 1020 provides for alignment (e.g., the user lining up) multiple screens for a multicolored design. Registration panel 1000 also assist to protect transparent member 78 from scratches, ink, and tape residue. A center portion 1010 is substantially transparent to allow the exposure light to shine through with minimal loss to the relevant wavelengths used to cure the emulsion on the screen. Registration holes 1030 allow registration panel 1000 to be placed on top of transparent member 78 and engage (see FIG. 1)

FIG. 11 is an example of method of registration 1100 for use with the screen printer, that may also be used with registration panel 1000. In an example, a computing device 1110 may be used in conjunction with a keyboard, mouse 110, and/or other input system (e.g., a touch screen) to prepare more than one digital representation of image, art, lettering, numbering, indicia or the like, which is shown generally at I_{D1}, I_{D2} (see also FIGS. 5A-5(3). As shown, the computing device 1110 is used by the user to prepare letters “A” and “B” for screen printing. Moreover, the letter “A” may be a different color than the letter “B”, which the design software may recognize that the screen printing process may require two (2) screens to print the different colors. The first screen may be configured using the techniques discussed herein to create a screen from artwork. However, the substantially transparent sheet of material used for pattern 1120 (see also S_{H}, for example, of FIG. 5B) used for the letter “A”, also includes indicia marks 1140 for alignment when placed over transparent member 78. Similarly, the pattern 1130 may include indicia marks 1140 as well as the pattern for the letter “B”. When patterns 1120, 1130 are overlaid with their respective indicia marks 1140 aligned, the pattern with “A” and “B” are represented similarly to the display on computing device 1110.

When registration panel 1000 is used, the registration holes 1030 align with the registration pegs 210 on the screen printer. Registration panel 1000 may then be taped down, or otherwise secured to the screen printer. However, the user may simply rest registration panel 1000 on the screen printer where the registration system maintains the position. The indicia marks 1140 of may be used with printed grid 1020 of registration panel 1000 allow the user to align each of patterns 1120, 1130 on registration panel 1000 using indicia marks 1140. To determine where the indicia may line up, the user may mark a point on printed grid 1020 to align indicia marks 1140. Alternatively, if the user desires to shift an image relative to another, the user may register the image to alternative points on printed grid 1020. In this way, printed grid 1020 allows the user to align and/or or shift images for more complex designs using multiple screens. Because the screen is registered with the lid of the screen printer, the registration of patterns 1120, 1130 using printed grid 1020 allows the user to maintain control over the location of the artwork to be imaged to the screen.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A screen printer, comprising:
a support portion; and
a cover portion movably-connected to the support portion, wherein the cover portion includes a body defining a passage, an upper surface, and a lower surface, wherein the lower surface includes a portion for retaining the screen body.

2. The screen printer according to claim 1, wherein the support portion comprises:
a base portion having a front surface, a rear surface and a top surface, a top cover member connected to the top surface of the base portion.

3. The screen printer according to claim 2, wherein the base portion further comprises:
at least one fan.

4. The screen printer according to claim 2, wherein said base portion further comprises:
at least one slot.

5. The screen printer according to claim 2, wherein said base portion further comprises:
at least one vent.

6. The screen printer according to claim 2, wherein said base portion further comprises:
at least one bulb.

7. The screen printer according to claim 4, wherein said at least one bulb comprises:
at least one fluorescent bulb.

8. The screen printer according to claim 2, wherein said base portion further comprises:
a lower registration system.

9. The screen printer according to claim 2, wherein said base portion further comprises:
an platen registration system.

10. The screen printer according to claim 2, wherein said cover portion further comprises:
an upper registration system.

11. The screen printer according to claim 2, further comprising:
adjustable legs.

12. The screen printer according to claim 2, further comprising:
hinges connecting said cover portion with each of said adjustable legs.

13. The screen printer according to claim 2, further comprising:
a substantially transparent member arranged on said top surface of said base portion.

14. A screen printer, comprising:
a lower portion comprising a lower registration system and a platen registration system; and
an upper portion comprising an upper registration system.

15. The screen printer according to claim 14, wherein said upper portion further comprises:
adjustable supports hingedly attached to said upper portion, said adjustable supports slidably engaging said lower portion.

16. The screen printer according to claim 14, said lower portion further comprising:
a door;
air vents; and
at least one fan.

17. The screen printer according to claim 14, further comprising:
a user accessible timer.

18. The screen printer according to claim 14, further comprising:
a screen body, said screen body including at least one hole for engaging said lower registration system and said upper registration system.

19. The screen printer according to claim 14, further comprising:
a substantially transparent member arranged on a top surface of said lower portion.

20. The screen printer according to claim 14, further comprising:
at least one bulb housed within said lower portion.
